(19) United States
(12) Patent Application Publication
(10) Pub. No.: US 2020/0320317 A1
(43) Pub. Date: Oct. 8, 2020

(54) INFORMATION DETECTION METHOD AND MOBILE DEVICE

(71) Applicant: HUAWEI TECHNOLOGIES CO., LTD., Shenzhen (CN)

(72) Inventors: Qiang Gu, Beijing (CN); Liu Liu, Beijing (CN); Jun Yao, London (GB)

(73) Assignee: HUAWEI TECHNOLOGIES CO., LTD., Shenzhen (CN)

(21) Appl. No.: 16/906,323

(22) Filed: Jun. 19, 2020

Related U.S. Application Data
(63) Continuation of application No. PCT/CN2017/117775, filed on Dec. 21, 2017.

(51) Int. Cl. G06K 9/00; G08G 1/00

(52) U.S. Cl. CPC G06K 9/00825; B60W 60/0025; G08G 1/20

(57) ABSTRACT

A method includes photographing a first picture, the first picture including a signal light at a first intersection; and detecting a signal light status in the first picture by using a first detection model. The first detection model is a detection model corresponding to the first intersection. The first detection model is obtained by a server through training based on signal light pictures corresponding to the first intersection and signal light statuses in the signal light pictures. The signal light statuses in the signal light pictures are obtained through detection by using a general model. The general model is obtained through training based on pictures in a first set and a signal light status in each picture in the first set. The first set includes signal light pictures of a plurality of intersections.

### CROSS-REFERENCE TO RELATED APPLICATIONS

This application is a continuation of International Application No. PCT/CN2017/117775, filed on Dec. 21, 2017, the disclosure of which is hereby incorporated by reference in its entirety.

### TECHNICAL FIELD

The present invention relates to the field of terminal technologies, and in particular, to an information detection method and a mobile device.

### BACKGROUND

In the field of vehicle self-driving, detection accuracy of a signal light status is of great significance to legality, regulation compliance, and safe driving of a vehicle. In an existing self-driving system in the industry, a machine learning method (for example, a deep learning method) is usually used to detect a signal light status. A process of detecting a signal light status by using a machine learning method is generally as follows: First, a device needs to collect a large quantity of signal light pictures, for example, collect 100 signal light pictures of an intersection 1, collect 100 signal light pictures of an intersection 2, and collect 100 signal light pictures of an intersection 3. In addition, signal light statuses in the 300 signal light pictures need to be input into the device, that is, colors and shapes of turned-on signal lights are input. The device performs training and learning by using the 300 signal light pictures and a signal light status in each signal light picture, to obtain a detection model. When a mobile device photographs a new signal light picture, the new signal light picture is input into the detection model, so that a signal light status in the signal light picture can be detected, that is, a color and a shape of a turned-on signal light in the signal light picture can be detected.

However, in the related art, a same detection model is used for signal light detection in all places, resulting in a comparatively low correctness percentage in detection of a signal light status by a mobile device.

### SUMMARY

Embodiments of the present invention disclose an information detection method and a mobile device, to help improve a correctness percentage in detection of a signal light status by the mobile device.

According to a first aspect, an embodiment of this application provides an information detection method. The method includes: photographing, by a mobile device, a first picture, where the first picture includes a signal light at a first intersection; and detecting, by the mobile device, a signal light status in the first picture by using a first detection model, where the first detection model is a detection model corresponding to the first intersection, the first detection model is obtained by a server through training based on signal light pictures corresponding to the first intersection and signal light statuses in the signal light pictures, the signal light statuses in the signal light pictures are obtained through detection by using a general model, the general model is obtained through training based on pictures in a first set and a signal light status in each picture in the first set, and the first set includes signal light pictures of a plurality of intersections.

In the related art, a mobile device detects a signal light status in a picture by using a general model. The general model is obtained through training based on signal light pictures of a plurality of intersections. Therefore, the general model is not well targeted, and it is not very accurate to detect a signal light status of an intersection by using the general model. In the method described in the first aspect, the signal light status of the first intersection is detected by using the detection model corresponding to the first intersection. The detection model corresponding to the first intersection is obtained through training based on the plurality of signal light pictures of the first intersection, and is not obtained through training with reference to a signal light picture of another intersection. Therefore, the detection model corresponding to the first intersection can better fit a signal light feature of the first intersection, thereby improving a correctness percentage in detection of the signal light status of the first intersection.

In addition, in the related art, when the general model is obtained through training based on signal light pictures, signal light statuses in the pictures are manually recognized, and the recognized signal light statuses are input into the device. Obtaining the general model through training requires a large quantity of pictures. Therefore, signal light statuses in the large quantity of pictures need to be manually recognized and input. This consumes a lot of manpower and is very unintelligent. In implementation of the method described in the first aspect, when the detection model corresponding to the first intersection is obtained through training based on the signal light pictures corresponding to the first intersection, the signal light statuses in the signal light pictures corresponding to the first intersection are automatically recognized by using the general model (that is, an existing model). Signal light statuses in a large quantity of pictures do not need to be manually recognized and input. The signal light statuses in the signal light pictures of the first intersection can be obtained more intelligently and conveniently. Therefore, the detection model corresponding to the first intersection can be obtained through training more quickly.

Optionally, before photographing the first picture, the mobile device may further perform the following operations: photographing, by the mobile device, a second picture, where the second picture includes a signal light at the first intersection; detecting, by the mobile device, a signal light status in the second picture by using the general model, to obtain a detection result; and sending, by the mobile device, first information to the server. The first information includes the second picture and the detection result, the first information further includes first geographical location information of the mobile device or an identifier of the first intersection, and the first geographical location information is used by the server to determine the identifier of the first intersection. There is a correspondence among the second picture, the detection result, and the identifier of the first intersection. The first information is used by the server to store the correspondence among the second picture, the detection result, and the identifier of the first intersection. The pictures and detection results that correspond to the identifier of the first intersection and that are stored in the server are used to obtain, through training, the detection model corresponding to the first intersection.

In this implementation, the mobile device can automatically identify the signal light statuses in the signal light pictures of the first intersection by using the general model (that is, the existing model). Therefore, signal light statuses in a large quantity of pictures do not need to be manually recognized and input, and the signal light statuses in the signal light pictures of the first intersection can be more intelligently and conveniently obtained. In addition, the mobile device can send the signal light pictures of the first intersection and the signal light statuses in the signal light pictures of the first intersection to the server, so that the server generates, based on the signal light pictures of the first intersection and the signal light statuses in the signal light pictures of the first intersection, the detection model corresponding to the first intersection.

Optionally, before detecting the signal light status in the first picture by using the first detection model, the mobile device may further perform the following operations: sending, by the mobile device to the server, an obtaining request used to obtain the first detection model, where the obtaining request carries second geographical location information of the mobile device or the identifier of the first intersection, and the second geographical location information is used by the server to determine the identifier of the first intersection; and receiving, by the mobile device, the first detection model sent by the server.

In this implementation, the mobile device may obtain the first detection model from the server, to detect the signal light status of the first intersection by using the first detection model.

Optionally, when the mobile device is within a preset range of the first intersection, if the first detection model does not exist in the mobile device, the mobile device may send, to the server, the obtaining request used to obtain the first detection model.

Optionally, when the mobile device is within the preset range of the first intersection, the mobile device receives the first detection model broadcast by the server.

In this implementation, the mobile device may obtain the first detection model from the server, to detect the signal light status of the first intersection by using the first detection model.

Optionally, before detecting the signal light status in the first picture by using the first detection model, the mobile device may further perform the following operation: obtaining, by the mobile device, the first detection model from a map application of the mobile device.

Optionally, when the mobile device detects, by using the map application, that the mobile device is within the preset range of the first intersection, the mobile device obtains the first detection model from the map application of the mobile device. In other words, in this implementation, after obtaining the first detection model through training, the server may integrate the first detection model into the map application. In this way, the server may not need to push the detection model to the mobile device, thereby helping save a transmission resource.

Optionally, the first detection model is a detection model corresponding to both the first intersection and a first direction. A specific implementation in which the mobile device photographs the first picture may be: photographing, by the mobile device, the first picture in the first direction of the first intersection. A specific implementation in which the mobile device photographs the second picture may be: photographing, by the mobile device, the second picture in the first direction of the first intersection. If the first information includes the first geographical location information, the first geographical location information is further used by the server to determine the first direction. If the first information includes the identifier of the first intersection, the first information further includes the first direction. There is a correspondence among the second picture, the detection result, the identifier of the first intersection, and the first direction. The first information is used by the server to store the correspondence among the second picture, the detection result, the identifier of the first intersection, and the first direction. Pictures and detection results that correspond to the identifier of the first intersection and the first direction and that are stored in the server are used to obtain, through training, the detection model corresponding to the first intersection and the first direction.

In this implementation, the mobile device may upload, to the server, a signal light picture photographed in the first direction of the first intersection and a corresponding detection result, so that the server can obtain, through training based on the received signal light picture and the corresponding detection result, the detection model corresponding to the first intersection and the first direction. The detection model corresponding to the first intersection and the first direction can better fit a feature of the signal light picture photographed in the first direction of the first intersection, thereby improving a correctness percentage in detection of a signal light status in the signal light picture photographed in the first direction of the first intersection.

Optionally, before detecting the signal light status in the first picture by using the first detection model, the mobile device may send, to the server, an obtaining request used to obtain the first detection model, where the obtaining request carries second geographical location information of the mobile device or carries the identifier of the first intersection and the first direction, and the second geographical location information is used by the server to determine the identifier of the first intersection and the first direction; and the mobile device receives the first detection model sent by the server.

In this implementation, the mobile device may obtain the first detection model from the server, to detect, by using the first detection model, the signal light status in the signal light picture photographed in the first direction of the first intersection.

Optionally, when detecting, by using the map application, that the mobile device is within the preset range of the first intersection, and detecting, by using the map application, that the mobile device is in the first direction of the first intersection, the mobile device obtains the first detection model from the map application of the mobile device. In other words, in this implementation, after obtaining the first detection model through training, the server may integrate the first detection model into the map application. In this way, the server may not need to push the detection model to the mobile device, thereby helping save a transmission resource.

Optionally, the first detection model is a detection model corresponding to all of the first intersection, the first direction, and a first lane. A specific implementation in which the mobile device photographs the first picture may be: photographing, by the mobile device, the first picture on the first lane in the first direction of the first intersection. A specific implementation in which the mobile device photographs the second picture may be: photographing, by the mobile device, the second picture on the first lane in the first direction of the first intersection. If the first information includes the first geographical location information, the first geographical location information is further used by the server to determine the first direction and an identifier of the first lane. If the first information includes the identifier of the first intersection, the first information further includes the first direction and the identifier of the first lane. There is a correspondence among the second picture, the detection result, the identifier of the first intersection, the first direction, and the identifier of the first lane. The first information is used by the server to store the correspondence among the second picture, the detection result, the identifier of the first intersection, the first direction, and the identifier of the first lane. Pictures and detection results that correspond to the identifier of the first intersection, the first direction, and the identifier of the first lane and that are stored in the server am used to obtain, through training, the detection model corresponding to all of the first intersection, the first direction, and the first lane.

In this implementation, the mobile device may upload, to the server, the signal light picture photographed on the first lane in the first direction of the first intersection and a corresponding detection result, so that the server can obtain, through training based on the received signal light picture and the corresponding detection result, the detection model corresponding to the first intersection, the first direction, and the first lane. The detection model corresponding to the first intersection, the first direction, and the first lane can better fit a feature of the signal light picture photographed on the first lane in the first direction of the first intersection, thereby improving a correctness percentage in detection of a signal light status in the signal light picture photographed on the first lane in the first direction of the first intersection.

Optionally, before detecting the signal light status in the first picture by using the first detection model, the mobile device may send, to the server, an obtaining request used to obtain the first detection model, where the obtaining request carries second geographical location information of the mobile device or carries the identifier of the first intersection, the first direction, and the identifier of the first lane, and the second geographical location information is used by the server to determine the identifier of the first intersection, the first direction, and the identifier of the first lane; and the mobile device receives the first detection model sent by the server.

In this implementation, the mobile device may obtain the first detection model from the server, to detect, by using the first detection model, the signal light status in the signal light picture photographed on the first lane in the first direction of the first intersection.

Optionally, when detecting, by using the map application, that the mobile device is within the preset range of the first intersection, and detecting, by using the map application, that the mobile device is on the first lane in the first direction of the first intersection, the mobile device obtains the first detection model from the map application of the mobile device. In other words, in this implementation, after obtaining the first detection model through training, the server may integrate the first detection model into the map application. In this way, the server may not need to push the detection model to the mobile device, thereby helping save a transmission resource.

According to a second aspect, an embodiment of this application provides a model generation method. The method includes: receiving, by a server, first information from a mobile device, where the first information includes a second picture and a detection result, the second picture includes a signal light at a first intersection, the detection result is obtained by the mobile device through detection of a signal light status in the second picture by using a general model, the general model is obtained through training based on pictures in a first set and a signal light status in each picture in the first set, the first set includes signal light pictures of a plurality of intersections, the first information further includes first geographical location information of the mobile device or an identifier of the first intersection, the first geographical location information is used by the server to determine the identifier of the first intersection, and there is a correspondence among the second picture, the detection result, and the identifier of the first intersection; storing, by the server, the correspondence among the second picture, the detection result, and the identifier of the first intersection; and obtaining, by the server through training based on pictures and detection results that correspond to the identifier of the first intersection and that are stored, a detection model corresponding to the first intersection.

In this implementation, the server generates, based on only signal light pictures of the first intersection and signal light statuses in the signal light pictures of the first intersection, the detection model corresponding to the first intersection, instead of obtaining, through training by using a signal light picture of another intersection, the detection model corresponding to the first intersection. In this way, the generated detection model corresponding to the first intersection can better fit a signal light feature of the first intersection, thereby improving a correctness percentage in detection of the signal light status of the first intersection.

Optionally, the server may further perform the following operations: receiving, by the server from the mobile device, an obtaining request used to obtain a first detection model, where the first detection model is the detection model corresponding to the first intersection, the obtaining request carries second geographical location information of the mobile device or the identifier of the first intersection, and the second geographical location information is used by the server to determine the identifier of the first intersection; determining, by the server, the first detection model based on the identifier of the first intersection; and returning, by the server, the first detection model to the mobile device.

In this implementation, the server may push the first detection model to the mobile device.

Optionally, the server broadcasts the first detection model to the mobile device located within a preset range of the first intersection, where the first detection model is the detection model corresponding to the first intersection.

In this implementation, the server may push the first detection model to the mobile device.

Optionally, the second picture is a picture photographed by the mobile device in a first direction of the first intersection. If the first information includes the first geographical location information, the first geographical location information is further used by the server to determine the first direction. If the first information includes the identifier of the first intersection, the first information further includes the first direction. There is a correspondence among the second picture, the detection result, the identifier of the first intersection, and the first direction. A specific implementation in which the server stores the correspondence among the second picture, the detection result, and the identifier of the first intersection is: storing, by the server, the correspondence among the second picture, the detection result, the identifier of the first intersection, and the first direction. A specific implementation in which the server obtains, through training based on the pictures and the detection results that correspond to the identifier of the first intersection and that are stored, the detection model corresponding to the first intersection is: obtaining, by the server through training based on pictures and detection results that correspond to the identifier of the first intersection and the first direction and that are stored, the detection model corresponding to the first intersection and the first direction.

In this implementation, the server may obtain, through training based on the received signal light picture and the corresponding detection result, the detection model corresponding to the first intersection and the first direction. The detection model corresponding to the first intersection and the first direction can better fit a feature of a signal light picture photographed in the first direction of the first intersection, thereby improving a correctness percentage in detection of the signal light status in the signal light picture photographed in the first direction of the first intersection.

Optionally, the server may further perform the following operations: receiving, by the server from the mobile device, an obtaining request used to obtain the first detection model, where the first detection model is the detection model corresponding to the first intersection and the first direction, the obtaining request carries second geographical location information of the mobile device or carries the identifier of the first intersection and the first direction, and the second geographical location information is used by the server to determine the identifier of the first intersection and the first direction; determining, by the server, the first detection model based on the identifier of the first intersection and the first direction; and returning, by the server, the first detection model to the mobile device.

In this implementation, the server may push the first detection model to the mobile device.

Optionally, the second picture is a picture photographed by the mobile device on a first lane in the first direction of the first intersection. If the first information includes the first geographical location information, the first geographical location information is further used by the server to determine the first direction and an identifier of the first lane. If the first information includes the identifier of the first intersection, the first information further includes the first direction and the identifier of the first lane. There is a correspondence among the second picture, the detection result, the identifier of the first intersection, the first direction, and the identifier of the first lane. A specific implementation in which the server stores the correspondence among the second picture, the detection result, and the identifier of the first intersection is: storing, by the server, the correspondence among the second picture, the detection result, the identifier of the first intersection, the first direction, and the identifier of the first lane. A specific implementation in which the server obtains, through training based on pictures and detection results that correspond to the identifier of the first intersection and that are stored, the detection model corresponding to the first intersection is: obtaining, by the server through training based on pictures and detection results that correspond to the identifier of the first intersection, the first direction, and the identifier of the first lane and that are stored, the detection model corresponding to the first intersection, the first direction, and the first lane.

In this implementation, the server may obtain, through training based on the received signal light picture and the corresponding detection result, the detection model corresponding to the first intersection, the first direction, and the first lane. The detection model corresponding to the first intersection, the first direction, and the first lane can better fit a feature of a signal light picture photographed on the first lane in the first direction of the first intersection, thereby improving a correctness percentage in detection of the signal light status in the signal light picture photographed on the first lane in the first direction of the first intersection.

Optionally, the server may further perform the following operations: receiving, by the server from the mobile device, an obtaining request used to obtain the first detection model, where the first detection model is the detection model corresponding to the first intersection, the first direction, and the first lane, the obtaining request carries second geographical location information of the mobile device or carries the identifier of the first intersection, the first direction, and the identifier of the first lane, and the second geographical location information is used by the server to determine the identifier of the first intersection, the first direction, and the identifier of the first lane; determining, by the server, the first detection model based on the identifier of the first intersection, the first direction, and the identifier of the first lane; and returning, by the server, the first detection model to the mobile device.

In this implementation, the server may push the first detection model to the mobile device.

According to a third aspect, a mobile device is provided. The mobile device may perform the method in the first aspect or the possible implementations of the first aspect. The function may be implemented by hardware, or may be implemented by hardware executing corresponding software. The hardware or the software includes one or more units corresponding to the foregoing functions. The unit may be software and/or hardware. Based on a same inventive concept, for problem-resolving principles and beneficial effects of the apparatus, refer to the problem-resolving principles and the beneficial effects of the first aspect or the possible implementations of the first aspect. No repeated description is provided.

According to a fourth aspect, a server is provided. The server may perform the method in the second aspect or the possible implementations of the second aspect. The function may be implemented by hardware, or may be implemented by hardware executing corresponding software. The hardware or the software includes one or more units corresponding to the foregoing functions. The unit may be software and/or hardware. Based on a same inventive concept, for problem-resolving principles and beneficial effects of the apparatus, refer to the problem-resolving principles and the beneficial effects of the second aspect or the possible implementations of the second aspect. No repeated description is provided.

According to a fifth aspect, a mobile device is provided. The mobile device includes a processor, a memory, and a communications interface. The processor, the communications interface, and the memory are connected. The communications interface may be a transceiver. The communications interface is configured to implement communication with another network element (such as a server). One or more programs are stored in the memory, and the processor invokes the program stored in the memory, to implement the solutions in the first aspect or the possible implementations of the first aspect. For problem-resolving implementations and beneficial effects of the mobile device, refer to the problem-resolving implementations and the beneficial effects of the first aspect or the possible implementations of the first aspect. No repeated description is provided.

According to a sixth aspect, a server is provided. The server includes a processor, a memory, and a communications interface. The processor, the communications interface, and the memory are connected. The communications interface may be a transceiver. The communications interface is configured to implement communication with another network element (such as a server). One or more programs are stored in the memory, and the processor invokes the program stored in the memory, to implement the solutions in the second aspect or the possible implementations of the second aspect. For problem-resolving implementations and beneficial effects of the server, refer to the problem-resolving implementations and the beneficial effects of the second aspect or the possible implementations of the second aspect. No repeated description is provided.

According to a seventh aspect, a computer program product is provided. When the computer program product runs on a computer, the computer is enabled to perform the method in the first aspect, the second aspect, the possible implementations of the first aspect, or the possible implementations of the second aspect.

According to an eighth aspect, a chip product of a mobile device is provided, to perform the first aspect and the possible implementations of the first aspect.

According to a ninth aspect, a chip product of a server is provided, to perform the second aspect and the possible implementations of the second aspect.

According to a tenth aspect, a computer-readable storage medium is provided. The computer-readable storage medium stores an instruction, and when the instruction is run on a computer, the computer is enabled to execute the first aspect, the second aspect, the possible implementations of the first aspect, or the possible implementations of the second aspect.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and persons of ordinary skill in the art may derive other drawings from these accompanying drawings without creative efforts.

FIG. 1 is a schematic diagram of a communications system according to an embodiment of the present invention;

FIG. 2 is a schematic flowchart of an information detection method according to an embodiment of the present invention;

FIG. 3 is a schematic diagram of a deep learning network according to an embodiment of the present invention;

FIG. 4 is a schematic flowchart of an information detection method according to an embodiment of the present invention;

FIG. 5 is a schematic diagram of obtaining a detection model through training according to an embodiment of the present invention;

FIG. 6 is a schematic diagram of obtaining a detection model through training according to an embodiment of the present invention;

FIG. 7 is a schematic diagram of obtaining a detection model through training according to an embodiment of the present invention;

FIG. 8 is a schematic flowchart of an information detection method according to an embodiment of the present invention;

FIG. 9 is a schematic flowchart of an information detection method according to an embodiment of the present invention;

FIG. 10 is a schematic flowchart of an information detection method according to an embodiment of the present invention;

FIG. 11 is a schematic structural diagram of a mobile device according to an embodiment of the present invention;

FIG. 12 is a schematic structural diagram of a server according to an embodiment of the present invention;

FIG. 13 is a schematic structural diagram of a mobile device according to an embodiment of the present invention;

FIG. 14 is a schematic structural diagram of a server according to an embodiment of the present invention.

### DESCRIPTION OF EMBODIMENTS

To make the objectives, technical solutions, and advantages of the present invention clearer, the following describes the technical solutions of the embodiments of the present invention with reference to the accompanying drawings.

The embodiments of this application provide an information detection method and a mobile device, to help improve a correctness percentage in detection of a signal light status by the mobile device.

For better understanding of the embodiments of this application, the following describes a communications system to which the embodiments of this application are applicable.

FIG. 1 is a schematic diagram of a communications system according to an embodiment of this application. As shown in FIG. 1, the communications system includes a mobile device and a server. Wireless communication may be performed between the mobile device and the server.

The mobile device may be a device, such as an automobile (for example, a self-driving vehicle or a person-driving vehicle) or an in-vehicle device, that needs to identify a signal light status. The signal light is a traffic signal light.

The server is configured to generate a detection model corresponding to an intersection, and the detection model is used by the mobile device to detect a signal light status at the intersection.

The following describes details of the information detection method and the mobile device provided in this application.

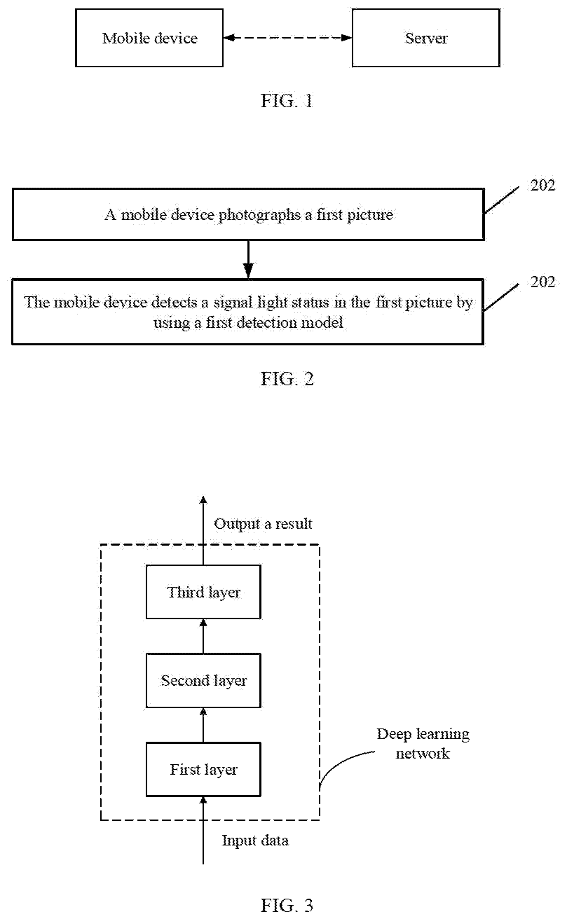

FIG. 2 is a schematic flowchart of an information detection method according to an embodiment of this application. As shown in FIG. 2, the information detection method includes the following 201 and 202.

201. A mobile device photographs a first picture.

The first picture includes a signal light at a first intersection. The first intersection may be any intersection. The signal light is a traffic signal light.

Optionally, the first picture may be a picture directly photographed by the mobile device, or the first picture may be a frame picture in video data photographed by the mobile device.

Optionally, the mobile device may photograph the first picture when the mobile device is within a preset range of the first intersection.

Specifically, the mobile device photographs the first picture by using a photographing apparatus of the mobile device. The photographing apparatus may be a camera or the like.

202. The mobile device detects a signal light status in the first picture by using a first detection model.

That the mobile device detects the signal light status in the first picture by using the first detection model may be: the mobile device detects a color and a shape of a turned-on signal light in the first picture by using the first detection model. The color of the turned-on signal light may be red, green, or yellow. The shape of the turned-on signal light may be a circle, an arrow pointing to the left, an arrow pointing to the right, an arrow pointing upwards, an arrow pointing downwards, or the like.

The first detection model is a detection model corresponding to the first intersection. The first detection model is obtained by the server through training based on signal light pictures corresponding to the first intersection and signal light statuses in the signal light pictures. The signal light statuses in the signal light pictures are obtained through detection by using a general model. The general model is obtained through training based on pictures in a first set and a signal light status in each picture in the first set. The first set includes signal light pictures of a plurality of intersections.

The signal light picture corresponding to the first intersection is a picture including a signal light at the first intersection. The first intersection may correspond to one or more signal light pictures. For example, the server may obtain the first detection model through training based on 100 signal light pictures corresponding to the first intersection and signal light statuses in the 100 signal light pictures. In other words, the server obtains the first detection model through training based on only the signal light pictures corresponding to the first intersection and the signal light statuses in the signal light pictures corresponding to the first intersection, instead of obtaining the first detection model through training based on a signal light picture of another intersection and a corresponding signal light status.

The first set includes signal light pictures of a plurality of intersections. For example, the first set includes 100 signal light pictures of the first intersection, 100 signal light pictures of a second intersection, and 100 signal light pictures of a third intersection. Therefore, the general model is obtained through training based on signal light pictures of a plurality of intersections and signal light statuses in the pictures.

Optionally, the server may obtain, through training by using a machine learning method (for example, a deep learning method) and based on the signal light pictures corresponding to the first intersection and the signal light statuses in the signal light pictures corresponding to the first intersection, the detection model corresponding to the first intersection. For example, as shown in FIG. 3, a deep learning network is set in the deep learning method. The deep learning network is divided into a plurality of layers, each layer performs nonlinear transformation such as convolution and pooling, and the layers are connected based on different weights. In FIG. 3, for example, there are three deep learning network layers. There may be less than three or more than three deep learning network layers. The server inputs the signal light pictures corresponding to the first intersection into the deep learning network for training. The server obtains input data of a next layer based on output data of a previous layer. The server compares a final output result of the deep learning network with the signal light status in the signal light picture, to adjust a weight of the deep learning network to form a model.

For example, 100 signal light pictures corresponding to the first intersection are respectively a picture 1 to a picture 100. The picture 1 to the picture 100 each include a signal light at the first intersection. The server inputs the picture 1 to the picture 100 into the deep learning network, and the server compares an output result of the deep learning network with signal light statuses in the picture 1 to the picture 100, to adjust a weight value of the deep learning network to finally obtain the first detection model. Therefore, after the first picture is input into the first detection model, the signal light status in the first picture may be recognized by using the first detection model.

The signal light statuses of the picture 1 to the picture 100 are detected by using the general model. The general model is obtained through training based on signal light pictures of a plurality of intersections and signal light statuses in the pictures. In other words, the general model is a model used to detect a signal light at any intersection, or a general detection algorithm used for a signal light at any intersection. A parameter in the general model is not adjusted for a specific intersection, and may be obtained by using a model or an algorithm in the related art.

In the related art, when the general model is obtained through training based on signal light pictures, signal light statuses in the pictures are manually recognized, and the recognized signal light statuses are input into the device. Obtaining the general model through training requires a large quantity of pictures. Therefore, signal light statuses in the large quantity of pictures need to be manually recognized and input. This consumes a lot of manpower and is very unintelligent. According to the method described in FIG. 2, when the detection model corresponding to the first intersection is trained based on the signal light pictures corresponding to the first intersection, the signal light statuses in the signal light pictures corresponding to the first intersection are automatically recognized by using the general model (that is, an existing model). The signal light statuses in the large quantity of pictures do not need to be manually recognized and input. The signal light statuses in the signal light pictures of the first intersection can be obtained more intelligently and conveniently. Therefore, the detection model corresponding to the first intersection can be obtained through training more quickly.

In the related art, a mobile device detects a signal light status in a picture by using a general model. The general model is obtained through training based on signal light pictures of a plurality of intersections. Therefore, the general model is not well targeted, and it is not very accurate to detect a signal light status of an intersection by using the general model. In the method described in FIG. 2, the signal light status of the first intersection is detected by using the detection model corresponding to the first intersection. The detection model corresponding to the first intersection is obtained through training based on the plurality of signal light pictures of the first intersection, and is not obtained through training by using a signal light picture of another intersection. Therefore, the detection model corresponding to the first intersection can better fit a signal light feature of the first intersection, thereby improving a correctness percentage in detection of a signal light status of the first intersection.

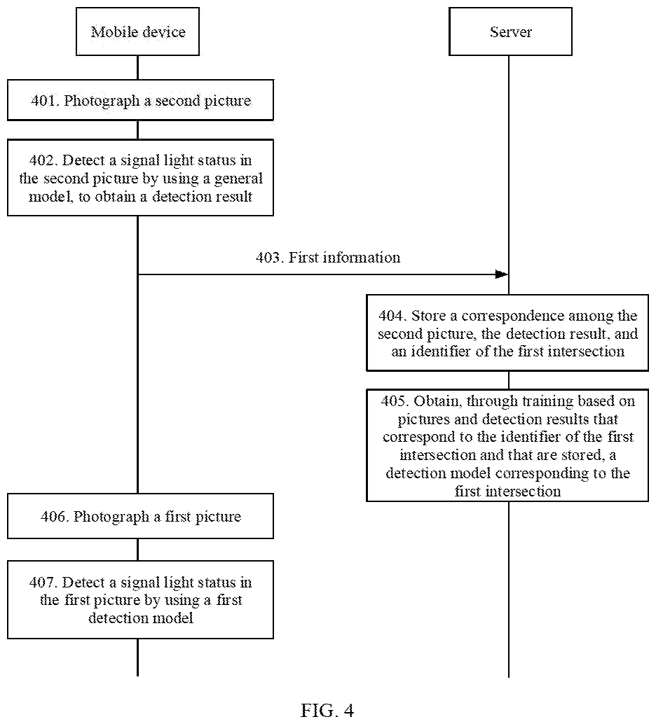

FIG. 4 is a schematic flowchart of an information detection method according to an embodiment of this application. As shown in FIG. 4, the information detection method includes the following 401 to 407.

401. A mobile device photographs a second picture.

The second picture includes a signal light at a first intersection.

Optionally, the second picture may be a picture directly photographed by the mobile device, or the second picture may be a frame picture in video data photographed by the mobile device.

Optionally, the mobile device may photograph the second picture when the mobile device is within a preset range of the first intersection.

Specifically, the mobile device photographs the second picture by using a photographing apparatus of the mobile device.

402. The mobile device detects a signal light status in the second picture by using a general model, to obtain a detection result.

For related descriptions of the general model, refer to corresponding descriptions in the embodiment described in FIG. 2. Details are not described herein.

403. The mobile device sends first information to a server.

The first information includes the second picture and the detection result, the first information further includes first geographical location information of the mobile device or an identifier of the first intersection, and the first geographical location information is used by the server to determine the identifier of the first intersection. There is a correspondence among the second picture, the detection result, and the identifier of the first intersection.

The first information is used by the server to store the correspondence among the second picture, the detection result, and the identifier of the first intersection. Pictures and detection results that correspond to the identifier of the first intersection and that are stored in the server are used to obtain, through training, a detection model corresponding to the first intersection.

Optionally, if the first information includes the identifier of the first intersection, the mobile device may obtain, by using a map application, an intersection identifier corresponding to current location information.

404. The server stores the correspondence among the second picture, the detection result, and the identifier of the first intersection.

If the first information includes the second picture, the detection result, and the identifier of the first intersection, after receiving the first information, the server stores the correspondence among the second picture, the detection result, and the identifier of the first intersection.

If the first information includes the second picture, the detection result, and the first geographical location information, after receiving the first information, the server first determines the first intersection from the map application based on the first geographical location information, and then stores the correspondence among the second picture, the detection result, and the identifier of the first intersection.

405. The server obtains, through training based on pictures and detection results that correspond to the identifier of the first intersection and that are stored, the detection model corresponding to the first intersection.

After obtaining, through training, the detection model corresponding to the first intersection, the server stores the detection model corresponding to the first intersection.

For example, the correspondence that is among a picture, a detection result, and the identifier of the first intersection and that is stored by the server may be shown in the following Table 1. The server obtains, through training based on a picture 1 to a picture 7 and a detection result 1 to a detection result 7, the detection model corresponding to the first intersection. Certainly, the pictures and the detection results in Table 1 may be sent by different terminal devices. For example, the picture 1 to the picture 3 are sent by a terminal device 1, and the picture 4 to the picture 7 are sent by a terminal device 2.

TABLE 1

| | Identifier of | | |
|---|---|---|---|
| Sequence | the first | | |
| number | intersection | Picture | Detection result |
| 1 | 1 | Picture 1 | Detection result 1 |
| 2 | 1 | Picture 2 | Detection result 2 |
| 3 | 1 | Picture 3 | Detection result 3 |
| 4 | 1 | Picture 4 | Detection result 4 |
| 5 | 1 | Picture 5 | Detection result 5 |
| 6 | 1 | Picture 6 | Detection result 6 |
| 7 | 1 | Picture 7 | Detection result 7 |

Certainly, the server may further store a picture and a detection result corresponding to another intersection, to obtain, through training, a detection model corresponding to the another intersection. For example, the server may further store a correspondence among a picture, a detection result, and an identifier of a second intersection, and the server may further store a correspondence among a picture, a detection result, and an identifier of a third intersection.

The server may obtain, through training by using a machine learning method (for example, a deep learning method) and based on the pictures and the detection results that correspond to the identifier of the first intersection and that are stored, the detection model corresponding to the first intersection.

Optionally, the server may obtain the detection model through training in any one of the following three manners.

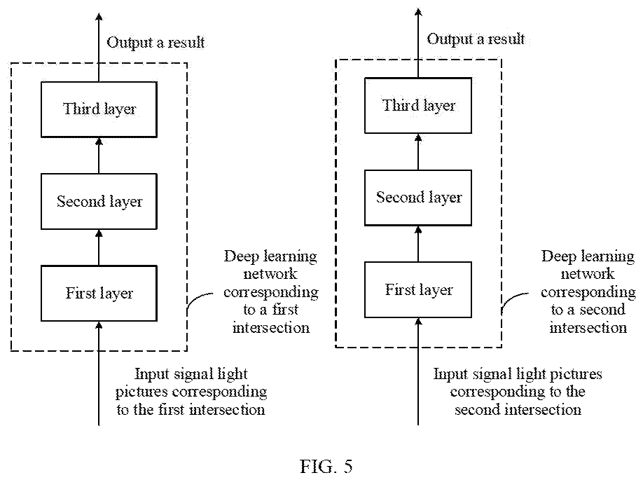

Manner 1: For example, the server obtains, through training the detection model corresponding to the first intersection and a detection model corresponding to the second intersection. As shown in FIG. 5, the server reads, based on the stored correspondence, a plurality of pictures corresponding to the first intersection, and inputs the plurality of pictures corresponding to the first intersection into a deep learning network corresponding to the first intersection. The server adjusts, based on an output result of the deep learning network corresponding to the first intersection and a detection result corresponding to the pictures, a weight in the deep learning network corresponding to the first intersection, to generate the detection model corresponding to the first intersection, and stores the model in the server. Then, the server reads, based on the stored correspondence, a plurality of pictures corresponding to the second intersection, and inputs the plurality of pictures corresponding to the second intersection into a deep learning network corresponding to the second intersection. The server compares an output result of the deep learning network corresponding to the second intersection with a detection result corresponding to the pictures, adjusts a weight in the deep learning network corresponding to the second intersection, to generate the detection model corresponding to the second intersection, and stores the model in the server.

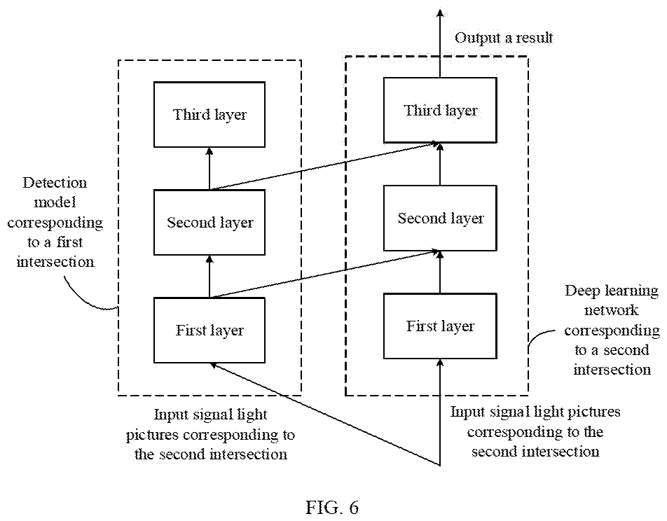

Manner 2: As shown in FIG. 6, the server reads, based on the stored correspondence, a plurality of pictures corresponding to the first intersection, and inputs the plurality of pictures corresponding to the first intersection into a deep learning network corresponding to the first intersection. The server adjusts, based on an output result of the deep learning network corresponding to the first intersection and a detection result corresponding to the pictures, a weight in the deep learning network corresponding to the first intersection, to generate the detection model corresponding to the first intersection, and stores the model in the server. The server reads, based on the stored correspondence, a plurality of pictures corresponding to the second intersection, inputs the plurality of pictures corresponding to the second intersection into a deep learning network corresponding to the second intersection, and simultaneously inputs the plurality of pictures corresponding to the second intersection into the detection model that corresponds to the first intersection and that is obtained through training. An output of an L^{th} layer obtained through training of the detection model corresponding to the first intersection is used as an additional input of an (L+1)^{th} layer of the deep learning network corresponding to the second intersection, where L≥0 and L≤M−1, and M is a total quantity of layers of the deep learning network corresponding to the second intersection. For example, as shown in FIG. 6, when obtaining, through training, the detection model corresponding to the second intersection, the server obtains, based on an output of a first layer of the deep learning network corresponding to the second intersection, an input of a second layer of the deep leaning network corresponding to the second intersection, and obtains, based on an output of a first layer of the detection model corresponding to the first intersection, an additional input of the second layer of the deep learning network corresponding to the second intersection. The server compares an output result of the deep learning network corresponding to the second intersection with the detection result corresponding to the pictures, adjusts a weight in the deep learning network corresponding to the second intersection, to obtain the detection model corresponding to the second intersection, and stores the model in the server.

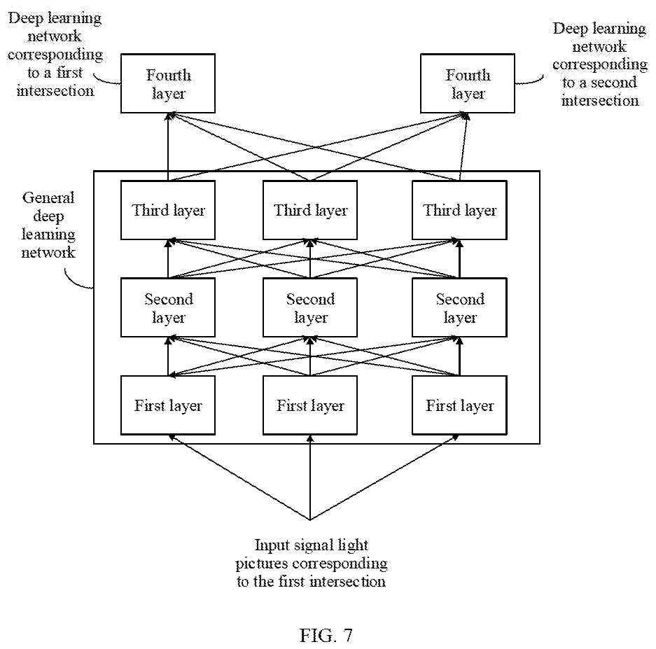

Manner 3: The first K layers of a deep learning network are a general deep learning network, the general deep learning network is shared by data of all intersections, and the last (M-K) layers are separately used by specific intersections, and are deep learning networks corresponding to the intersections. A traffic light recognition model is generated for each intersection. As shown in FIG. 7, for example, K is equal to 3. The server first reads, based on the stored correspondence, a plurality of pictures corresponding to the first intersection, and inputs the plurality of pictures corresponding to the first intersection into the general deep learning network. The server obtains, based on an output of a third layer, an input of a deep learning network corresponding to the first intersection, and the server adjusts, based on an output result of the deep learning network corresponding to the first intersection and a detection result corresponding to the pictures, a weight in the deep learning network corresponding to the first intersection, to generate the detection model corresponding to the first intersection, and stores the model in the server. Similarly, the server reads, based on the stored correspondence, a plurality of pictures corresponding to the second intersection, and inputs the plurality of pictures corresponding to the second intersection into the general deep learning network. The server obtains, based on the output of the third layer, an input of the deep learning network corresponding to the second intersection, and the server adjusts, based on an output result of the deep learning network corresponding to the second intersection and a detection result corresponding to the pictures, a weight in the deep learning network corresponding to the second intersection, to generate the detection model corresponding to the second intersection, and stores the model in the server.

406. The mobile device photographs a first picture.

The first picture includes a signal light at the first intersection.

407. The mobile device detects a signal light status in the first picture by using a first detection model.

The first detection model is the detection model corresponding to the first intersection.

For specific implementations of 406 and 407, refer to descriptions corresponding to 202 and 201 in FIG. 2. Details are not described herein.

As can be learned, by performing 401 to 405, the mobile device can automatically recognize the signal light status in the signal light picture of the first intersection by using the general model (that is, an existing model). Therefore, signal light statuses in a large quantity of pictures do not need to be manually recognized and input, and the signal light status in the signal light picture of the first intersection can be more intelligently and conveniently obtained. In addition, the mobile device can send the signal light pictures of the first intersection and the signal light statuses in the signal light pictures of the first intersection to the server, so that the server generates, based on the signal light pictures of the first intersection and the signal light statuses in the signal light picture of the first intersection, the detection model corresponding to the first intersection. The server generates, based on only the signal light pictures of the first intersection and the signal light statuses in the signal light pictures of the first intersection, the detection model corresponding to the first intersection, instead of obtaining, through training by using a signal light picture of another intersection, the detection model corresponding to the first intersection. Therefore, the generated detection model corresponding to the first intersection can better fit a signal light feature of the first intersection, and a correctness percentage in detection of a signal light status at the first intersection can be improved.

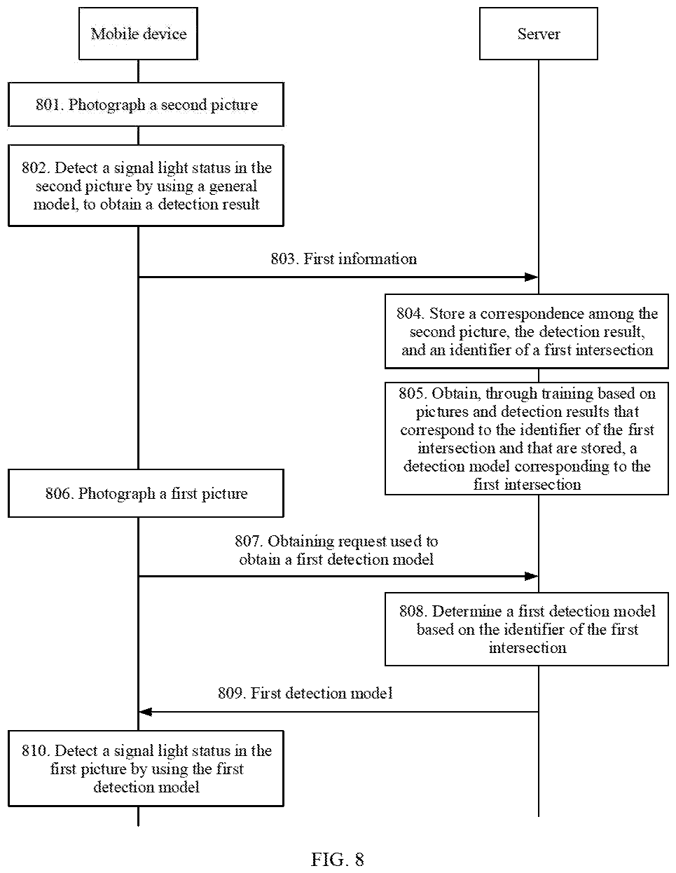

Optionally, as shown in FIG. 8, before the mobile device detects the signal light status in the first picture by using the first detection model, the mobile device and the server may further perform the following 807 to 809, 806 and 807 may be simultaneously performed, 806 may be performed before 807, or 806 may be performed after 807 to 809.

807. The mobile device sends, to the server, an obtaining request used to obtain the first detection model, where the obtaining request carries second geographical location information of the mobile device or the identifier of the first intersection, and the second geographical location information is used by the server to determine the identifier of the first intersection.

Optionally, when the mobile device is within the preset range of the first intersection, if the first detection model does not exist in the mobile device, the mobile device may send, to the server, the obtaining request used to obtain the first detection model.

808. The server determines the first detection model based on the identifier of the first intersection.

If the obtaining request carries the second geographical location information of the mobile device, after receiving the obtaining request from the mobile device, the server determines the identifier of the first intersection from the map application based on the second geographical location information, and then determines, from the stored detection model based on the identifier of the first intersection, the first detection model corresponding to the identifier of the first intersection.

If the obtaining request carries the identifier of the first intersection, after receiving the obtaining request from the mobile device, the server determines, from the stored detection model based on the identifier of the first intersection, the first detection model corresponding to the identifier of the first intersection.

809. The server returns the first detection model to the mobile device.

After the server returns the first detection model to the mobile device, the mobile device receives the first detection model sent by the server.

The mobile device may obtain the first detection model from the server by performing 807 to 809, to detect the signal light status of the first intersection by using the first detection model.

Optionally, the server broadcasts the first detection model to the mobile device located within the preset range of the first intersection. Correspondingly, when the mobile device is within the preset range of the first intersection, the mobile device may further receive the first detection model broadcast by the server.

In this implementation, the server includes a model pushing apparatus and a model generation apparatus, and the model pushing apparatus and the model generation apparatus are deployed in different places. The model generation apparatus is configured to generate a detection model corresponding to each intersection. The model pushing apparatus is deployed at each intersection. The model pushing apparatus is configured to broadcast a detection model to a mobile device located within a preset range of an intersection. For example, a model pushing apparatus 1 is deployed at the first intersection, a model pushing apparatus 2 is deployed at the second intersection, and a model pushing apparatus 3 is deployed at the third intersection. The model generation apparatus sends the detection model corresponding to the first intersection to the model pushing apparatus 1, sends the detection model corresponding to the second intersection to the model pushing apparatus 2, and sends the detection model corresponding to the third intersection to the model pushing apparatus 3. The model pushing apparatus 1 is configured to broadcast, to the mobile device located within the preset range of the first intersection, the detection model corresponding to the first intersection. The model pushing apparatus 2 is configured to broadcast, to a mobile device located within a preset range of the second intersection, the detection model corresponding to the second intersection. The model pushing apparatus 3 is configured to broadcast, to a mobile device located within a preset range of the third intersection, the detection model corresponding to the third intersection.

In this implementation, the mobile device may obtain the first detection model from the server, to detect the signal light status of the first intersection by using the first detection model.

Optionally, before detecting the signal light status in the first picture by using the first detection model, the mobile device obtains the first detection model from the map application of the mobile device. Optionally, when the mobile device detects, by using the map application, that the mobile device is within the preset range of the first intersection, the mobile device obtains the first detection model from the map application of the mobile device. In other words, in this implementation, after obtaining the first detection model through training, the server may integrate the first detection model into the map application. In this way, the server may not need to push the detection model to the mobile device, thereby helping save a transmission resource.

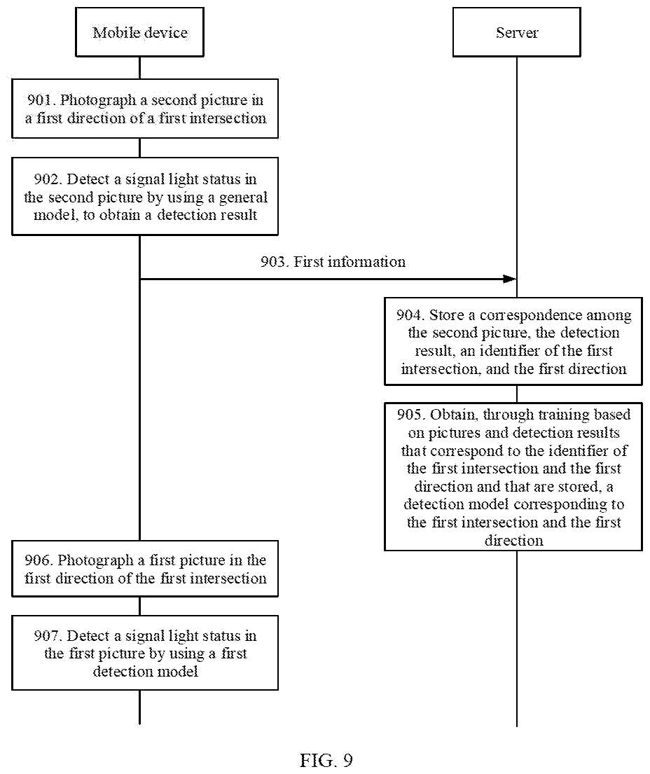

FIG. 9 is a schematic flowchart of an information detection method according to an embodiment of this application. As shown in FIG. 9, the information detection method includes the following 901 to 907.

901. A mobile device photographs a second picture in a first direction of a first intersection.

The second picture includes a signal light at the first intersection.

The first direction may be any direction of east, west, south, and north.

902. The mobile device detects a signal light status in the second picture by using a general model, to obtain a detection result.

For related descriptions of the general model, refer to corresponding descriptions in the embodiment described in FIG. 1. Details are not described herein.

903. The mobile device sends first information to a server.

The first information includes the second picture and the detection result, the first information further includes first geographical location information of the mobile device or the first information further includes an identifier of the first intersection and the first direction, and the first geographical location information is used by the server to determine the identifier of the first intersection and the first direction. There is a correspondence among the second picture, the detection result, the identifier of the first intersection, and the first direction.

The first information is used by the server to store the correspondence among the second picture, the detection result, the identifier of the first intersection, and the first direction. Pictures and detection results that correspond to the identifier of the first intersection and the first direction and that are stored in the server are used to obtain, through training, a detection model corresponding to the first intersection and the first direction.

Optionally, if the first information includes the identifier of the first intersection and the first direction, the mobile device may obtain current location information by using the map application, and then determine, based on the current location information, the identifier and the first direction that correspond to the first intersection.

904. The server stores the correspondence among the second picture, the detection result, the identifier of the first intersection, and the first direction.

After receiving the first information, the server stores the correspondence among the second picture, the detection result, the identifier of the first intersection, and the first direction.

If the first information includes the second picture, the detection result, the identifier of the first intersection, and the first direction, after receiving the first information, the server stores the correspondence among the second picture, the detection result, the identifier of the first intersection, and the first direction.

If the first information includes the second picture, the detection result, and the first geographical location information, after receiving the first information, the server first determines the identifier of the first intersection and the first direction from the map application based on the first geographical location information, and then stores the correspondence among the second picture, the detection result, the identifier of the first intersection, and the first direction.

905. The server obtains, through training based on the pictures and the detection results that correspond to the identifier of the first intersection and the first direction and that are stored, the detection model corresponding to the first intersection and the first direction.

After obtaining, through training, the detection model corresponding to the first intersection and the first direction, the server stores the detection model corresponding to the first intersection.

For example, the correspondence that is among a picture, a detection result, the identifier of the first intersection, and the first direction and that is stored by the server may be shown in the following Table 2. The server obtains, through training based on a picture 1 to a picture 7 and a detection result 1 to a detection result 7, the detection model corresponding to the first intersection and the first direction. Certainly, the pictures and the detection results in Table 2 may be sent by different terminal devices. For example, the picture 1 to the picture 3 are sent by a terminal device 1, and the picture 4 to the picture 7 are sent by a terminal device 2.

TABLE 2

| | Identifier of | | | |
|---|---|---|---|---|
| Sequence | the first | First | | |
| number | intersection | direction | Picture | Detection result |
| 1 | 1 | East | Picture 1 | Detection result 1 |
| 2 | 1 | East | Picture 2 | Detection result 2 |
| 3 | 1 | East | Picture 3 | Detection result 3 |
| 4 | 1 | East | Picture 4 | Detection result 4 |
| 5 | 1 | East | Picture 5 | Detection result 5 |
| 6 | 1 | East | Picture 6 | Detection result 6 |
| 7 | 1 | East | Picture 7 | Detection result 7 |

Certainly, the server may further store a correspondence among a picture, a detection result, the first intersection, and another direction, to obtain, through training, a detection model corresponding to the first intersection and the another direction. For example, the server may further store a correspondence among a picture, a detection result, the identifier of the first intersection, and a second direction, and the server may further store a correspondence among a picture, a detection result, the identifier of the first intersection, and a third direction. Certainly, the server may further store a correspondence among a picture, a detection result, another intersection, and another direction.

The server may obtain, through training by using a machine learning method (for example, a deep learning method) and based on the pictures and the detection results that correspond to the identifier of the first intersection and the first direction and that are stored, the detection model corresponding to the first intersection and the first direction. Optionally, a training principle of the detection model corresponding to the first intersection and the first direction is similar to those in FIG. 5. FIG. 6, and FIG. 7. Refer to the training principles corresponding to FIG. 5, FIG. 6, and FIG. 7. Details are not described herein.

906. The mobile device photographs a first picture in the first direction of the first intersection.

The first picture includes a signal light at the first intersection.

The first direction may be any direction of east, west, south, and north.

907. The mobile device detects a signal light status in the first picture by using a first detection model.

The first detection model is the detection model corresponding to the first intersection and the first direction.

In implementation of the method shown in FIG. 9, the mobile device may upload, to the server, a signal light picture photographed in the first direction of the first intersection and a corresponding detection result, so that the server can obtain, through training based on the received signal light picture and the corresponding detection result, the detection model corresponding to the first intersection and the first direction. The detection model corresponding to the first intersection and the first direction can better fit a feature of the signal light picture photographed in the first direction of the first intersection, thereby improving a correctness percentage in detection of a signal light status in the signal light picture photographed in the first direction of the first intersection.

Optionally, before detecting the signal light status in the first picture by using the first detection model, the mobile device may send, to the server, an obtaining request used to obtain the first detection model, where the obtaining request carries second geographical location information of the mobile device or carries the identifier of the first intersection and the first direction, and the second geographical location information is used by the server to determine the identifier of the first intersection and the first direction. After receiving the obtaining request from the mobile device, the server determines the first detection model based on the identifier of the first intersection and the first direction. The server returns the first detection model to the mobile device, and the mobile device receives the first detection model sent by the server.

Specifically, if the obtaining request carries the second geographical location information, after receiving the obtaining request, the server obtains, from the map application based on the second geographical location information, the identifier of the first intersection and the first direction corresponding to the second geographical location information, and then determines the first detection model based on the identifier of the first intersection and the first direction.

In this implementation, the mobile device may obtain the first detection model from the server, to detect, by using the first detection model, the signal light status in the signal light picture photographed in the first direction of the first intersection.

Optionally, when detecting, by using the map application, that the mobile device is within a preset range of the first intersection, and detecting, by using the map application, that the mobile device is in the first direction of the first intersection, the mobile device obtains the first detection model from the map application of the mobile device. In other words, in this implementation, after obtaining the first detection model through training, the server may integrate the first detection model into the map application. In this way, the server may not need to push the detection model to the mobile device, thereby helping save a transmission resource.

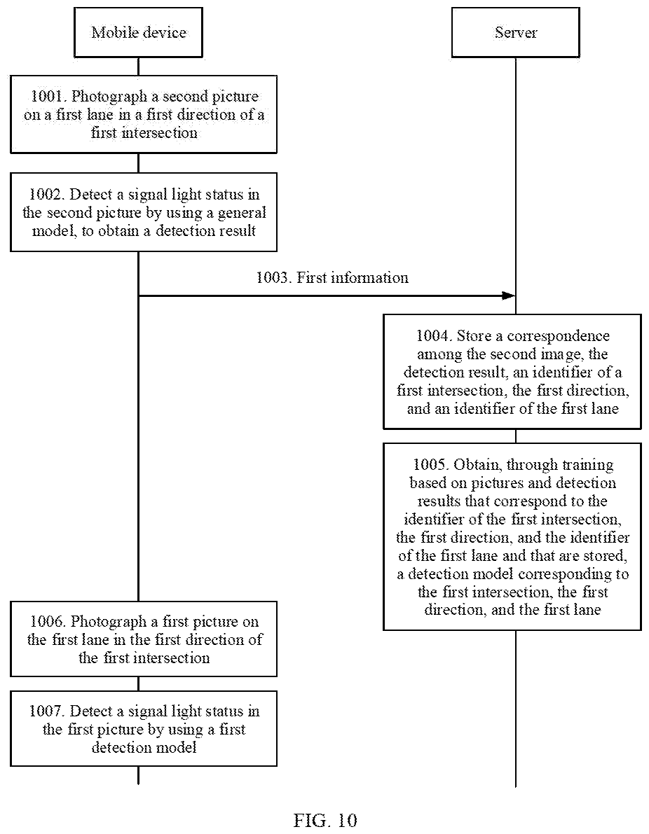

FIG. 10 is a schematic flowchart of an information detection method according to an embodiment of this application. As shown in FIG. 10, the information detection method includes the following 1001 to 1007.

1001. A mobile device photographs a second picture on a first lane of a first direction of a first intersection.

The second picture includes a signal light at the first intersection.

The first direction may be any direction of east, west, south, and north. Generally, one direction of an intersection has one or more lanes, and the first lane is any lane in the first direction.

1002. The mobile device detects a signal light status in the second picture by using a general model, to obtain a detection result.

For related descriptions of the general model, refer to corresponding descriptions in the embodiment described in FIG. 1. Details are not described herein.

1003. The mobile device sends first information to a server.

The first information includes the second picture and the detection result. The first information further includes first geographical location information of the mobile device or the first information further includes an identifier of the first intersection, the first direction, and an identifier of the first lane. The first geographical location information is used by the server to determine the identifier of the first intersection, the first direction, and the identifier of the first lane. There is a correspondence among the second picture, the detection result, the identifier of the first intersection, the first direction, and the identifier of the first lane.

The first information is used by the server to store the correspondence among the second picture, the detection result, the identifier of the first intersection, the first direction, and the identifier of the first lane. Pictures and detection results that correspond to the identifier of the first intersection, the first direction, and the identifier of the first lane and that are stored in the server are used to obtain, through training, the detection model corresponding to the first intersection and the first direction.

Optionally, if the first information includes the identifier of the first intersection, the first direction, and the identifier of the first lane, the mobile device may obtain current location information by using a map application, and then determine, based on the current location information, the identifier, the first direction, and the identifier of the first lane that correspond to the first intersection.

1004. The server stores the correspondence among the second picture, the detection result, the identifier of the first intersection, the first direction, and the identifier of the first lane.

After receiving the first information, the server stores the correspondence among the second picture, the detection result, the identifier of the first intersection, the first direction, and the identifier of the first lane.

If the first information includes the second picture, the detection result, the identifier of the first intersection, the first direction, and the identifier of the first lane, after receiving the first information, the server stores the correspondence among the second picture, the detection result, the identifier of the first intersection, the first direction, and the identifier of the first lane.

If the first information includes the second picture, the detection result, and the first geographical location information, after receiving the first information, the server first determines the identifier of the first intersection, the first direction, and the identifier of the first lane from the map application based on the first geographical location information, and then stores the correspondence among the second picture, the detection result, the identifier of the first intersection, the first direction, and the identifier of the first lane.

1005. The server obtains, through training based on the pictures and the detection results that correspond to the identifier of the first intersection, the first direction, and the identifier of the first lane and that are stored, a detection model corresponding to the first intersection, the first direction, and the first lane.

After obtaining, through training, the detection model corresponding to the first intersection, the first direction, and the first lane, the server stores the detection model corresponding to the first intersection, the first direction, and the first lane.

For example, the correspondence that is among a picture, a detection result, the identifier of the first intersection, the first direction, and the identifier of the first lane and that is stored by the server may be shown in the following Table 3. The server obtains, through training based on a picture 1 to a picture 7 and a detection result 1 to a detection result 7, the detection model corresponding to the first intersection, the first direction, and the first lane. Certainly, the pictures and the detection results in Table 3 may be sent by different terminal devices. For example, the picture 1 to the picture 3 are sent by a terminal device 1, and the picture 4 to the picture 7 are sent by a terminal device 2.

TABLE 3

| | Identifier of | | Identifier of | | |
|---|---|---|---|---|---|
| Sequence | the first | First | the first | | |
| number | intersection | direction | lane | Photo | Detection result |
| 1 | 1 | East | 1 | Picture 1 | Detection result 1 |
| 2 | 1 | East | 1 | Picture 2 | Detection result 2 |
| 3 | 1 | East | 1 | Picture 3 | Detection result 3 |
| 4 | 1 | East | 1 | Picture 4 | Detection result 4 |
| 5 | 1 | East | 1 | Picture 5 | Detection result 5 |
| 6 | 1 | East | 1 | Picture 6 | Detection result 6 |
| 7 | 1 | East | 1 | Picture 7 | Detection result 7 |

Certainly, the server may further store a correspondence among a picture, a detection result, the first intersection, the first direction, and an identifier of another lane, to obtain, through training a detection model corresponding to the first intersection, the first direction, and the another lane.

The server may obtain, through training by using a machine learning method (for example, a deep learning method) and based on the pictures and detection results that correspond to the identifier of the first intersection, the first direction, and the identifier of the first lane and that are stored, the detection model corresponding to the first intersection, the first direction, and the first lane. Optionally, a training principle of the detection model corresponding to the first intersection, the first direction, and the first lane is similar to those in FIG. 5, FIG. 6, and FIG. 7. Refer to the training principles corresponding to FIG. 5, FIG. 6, and FIG. 7. Details are not described herein.

1006. The mobile device photographs a first picture on the first lane in the first direction of the first intersection.

The first picture includes a signal light at the first intersection.

The first direction may be any direction of east, west, south, and north. The first lane is any lane in the first direction.

1007. The mobile device detects a signal light status in the first picture by using a first detection model.

The first detection model is the detection model corresponding to the first intersection, the first direction, and the first lane.

In implementation of the method shown in FIG. 10, the mobile device may upload, to the server, a signal light picture photographed on the first lane in the first direction of the first intersection and a corresponding detection result, so that the server can obtain, through training based on the received signal light picture and the corresponding detection result, the detection model corresponding to the first intersection, the first direction, and the first lane. The detection model corresponding to the first intersection, the first direction, and the first lane can better fit a feature of a signal light picture photographed on the first lane in the first direction of the first intersection, thereby improving a correctness percentage in detection of a signal light status in the signal light picture photographed on the first lane in the first direction of the first intersection.

Optionally, before detecting the signal light status in the first picture by using the first detection model, the mobile device may send, to the server, an obtaining request used to obtain the first detection model, where the obtaining request carries second geographical location information of the mobile device or carries the identifier of the first intersection, the first direction, and the identifier of the first lane. The second geographical location information is used by the server to determine the identifier of the first intersection, the first direction, and the identifier of the first lane. After receiving the obtaining request from the mobile device, the server determines the first detection model based on the identifier of the first intersection, the first direction, and the identifier of the first lane. The server returns the first detection model to the mobile device, and the mobile device receives the first detection model sent by the server.

Specifically, if the obtaining request carries the second geographical location information, after receiving the obtaining request, the server obtains, from the map application based on the second geographical location information, the identifier of the first intersection, the first direction, and the identifier of the first lane that correspond to the second geographical location information, and then determines the first detection model based on the identifier of the first intersection, the first direction, and the identifier of the first lane.

In this implementation, the mobile device may obtain the first detection model from the server, to detect, by using the first detection model, the signal light status in the signal light picture photographed on the first lane in the first direction of the first intersection.

Optionally, when detecting, by using the map application, that the mobile device is within the preset range of the first intersection, and detecting, by using the map application, that the mobile device is on the first lane in the first direction of the first intersection, the mobile device obtains the first detection model from the map application of the mobile device. In other words, in this implementation, after obtaining the first detection model through training, the server may integrate the first detection model into the map application. In this way, the server may not need to push the detection model to the mobile device, thereby helping save a transmission resource.

In the embodiments of the present invention, division into functional modules may be performed on the device based on the foregoing method examples. For example, division into each functional module may be performed for each function, or two or more functions may be integrated into one module. The integrated module may be implemented in a form of hardware, or may be implemented in a form of a software functional module. It should be noted that, in the embodiments of the present invention, division into the modules is an example, is merely logical function division, and may be other division in an actual implementation.

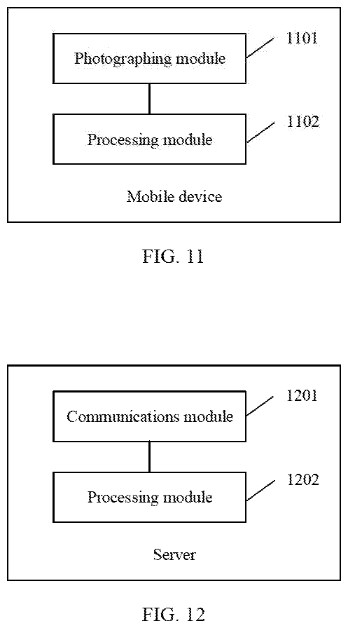

FIG. 11 shows a mobile device according to an embodiment of the present invention. The mobile device includes a photographing nodule 1101 and a processing module 1102.

The photographing module 1101 is configured to photograph a first picture. The first picture includes a signal light at a first intersection.

The processing module 1102 is configured to detect a signal light status in the first picture by using a first detection model. The first detection model is a detection model corresponding to the first intersection, the first detection model is obtained by a server through training based on signal light pictures corresponding to the first intersection and signal light statuses in the signal light pictures, the signal light statuses in the signal light pictures are obtained through detection by using a general model, the general model is obtained through training based on pictures in a first set and a signal light status in each picture in the first set, and the first set includes signal light pictures of a plurality of intersections.

Optionally, the mobile device further includes a communications module. The photographing module 1101 is further configured to photograph a second picture. The second picture includes a signal light at the first intersection. The processing module 1102 is further configured to detect a signal light status in the second picture by using the general model, to obtain a detection result. The communications module is configured to send first information to the server. The first information includes the second picture and the detection result, the first information further includes first geographical location information of the mobile device or an identifier of the first intersection, and the first geographical location information is used by the server to determine the identifier of the first intersection. There is a correspondence among the second picture, the detection result, and the identifier of the first intersection. The first information is used by the server to store the correspondence among the second picture, the detection result, and the identifier of the first intersection. The pictures and detection results that correspond to the identifier of the first intersection and that are stored in the server are used to obtain, through training, the detection model corresponding to the first intersection.

Optionally, the mobile device further includes a communications module. The communications module is configured to send, to the server, an obtaining request used to obtain the first detection model. The obtaining request carries second geographical location information of the mobile device or the identifier of the first intersection, and the second geographical location information is used by the server to determine the identifier of the first intersection. The communications module is further configured to receive the first detection model sent by the server.

Optionally, the mobile device further includes a communications module. The communications module is configured to: when the mobile device is within a preset range of the first intersection, receive the first detection model broadcast by the server.

Optionally, the processing module 1102 is further configured to obtain the first detection model from a map application of the mobile device.

Optionally, the first detection model is a detection model corresponding to both the first intersection and a first direction. A manner in which the photographing module 1101 photographs the first picture is specifically: photographing, by the photographing module 1101, the first picture in the first direction of the first intersection. A manner in which the photographing module 1101 photographs the second picture is specifically: photographing, by the photographing module 1101, the second picture in the first direction of the first intersection. If the first information includes the first geographical location information, the first geographical location information is further used by the server to determine the first direction. If the first information includes the identifier of the first intersection, the first information further includes the first direction. There is a correspondence among the second picture, the detection result, the identifier of the first intersection, and the first direction. The first information is used by the server to store the correspondence among the second picture, the detection result, the identifier of the first intersection, and the first direction. Pictures and detection results that correspond to the identifier of the first intersection and the first direction and that are stored in the server are used to obtain, through training, the detection model corresponding to the first intersection and the first direction.

Optionally, the first detection model is a detection model corresponding to all of the first intersection, the first direction, and a first lane. A manner in which the photographing module 1101 photographs the first picture is specifically: photographing, by the photographing module 1101, the first picture on the first lane in the first direction of the first intersection. A manner in which the photographing module 1101 photographs the second picture is specifically: photographing, by the photographing module 1101, the second picture on the first lane in the first direction of the first intersection. If the first information includes the first geographical location information, the first geographical location information is further used by the server to determine the first direction and an identifier of the first lane. If the first information includes the identifier of the first intersection, the first information further includes the first direction and the identifier of the first lane. There is a correspondence among the second picture, the detection result, the identifier of the first intersection, the first direction, and the identifier of the first lane. The first information is used by the server to store the correspondence among the second picture, the detection result, the identifier of the first intersection, the first direction, and the identifier of the first lane. Pictures and detection results that correspond to the identifier of the first intersection, the first direction, and the identifier of the first lane and that are stored in the server are used to obtain, through training, the detection model corresponding to all of the first intersection, the first direction, and the first lane.

FIG. 12 shows a server according to an embodiment of the present invention. The server includes a communications module 1201 and a processing module 1202.

The communications module 1201 is configured to receive first information from a mobile device. The first information includes a second picture and a detection result, the second picture includes a signal light at a first intersection, the detection result is obtained by the mobile device through detection of a signal light status in the second picture by using a general model, the general model is obtained through training based on pictures in a first set and a signal light status in each picture in the first set, the first set includes signal light pictures of a plurality of intersections, the first information further includes first geographical location information of the mobile device or an identifier of the first intersection, the first geographical location information is used by the server to determine the identifier of the first intersection, and there is a correspondence among the second picture, the detection result, and the identifier of the first intersection.

The processing module 1202 is configured to store the correspondence among the second picture, the detection result, and the identifier of the first intersection.

The processing module 1202 is further configured to obtain, through training based on pictures and detection results that correspond to the identifier of the first intersection and that are stored, a detection model corresponding to the first intersection.

Optionally, the communications module 1201 is further configured to receive, from the mobile device, an obtaining request used to obtain a first detection model. The first detection model is the detection model corresponding to the first intersection, the obtaining request carries second geographical location information of the mobile device or the identifier of the first intersection, and the second geographical location information is used by the server to determine the identifier of the first intersection. The processing module 1202 is further configured to determine the first detection model based on the identifier of the first intersection. The communications module 1201 is further configured to return the first detection model to the mobile device.

Optionally, the communications module 1201 is further configured to broadcast the first detection model to the mobile device located within a preset range of the first intersection. The first detection model is the detection model corresponding to the first intersection.

Optionally, the second picture is a picture photographed by the mobile device in a first direction of the first intersection. If the first information includes the first geographical location information, the first geographical location information is further used by the server to determine the first direction. If the first information includes the identifier of the first intersection, the first information further includes the first direction. There is a correspondence among the second picture, the detection result, the identifier of the first intersection, and the first direction. A manner in which the processing module 1202 stores the correspondence among the second picture, the detection result, and the identifier of the first intersection is specifically: storing, by the processing module 1202, the correspondence among the second picture, the detection result, the identifier of the first intersection, and the first direction. A manner in which the processing module 1202 obtains, through training based on the pictures and the detection results that correspond to the identifier of the first intersection and that are stored, the detection model corresponding to the first intersection is specifically: obtaining, by the processing module 1202 through training based on pictures and detection results that correspond to the identifier of the first intersection, the first direction, and the identifier of the first lane and that are stored, the detection model corresponding to the first intersection and the first direction.

Optionally, the second picture is a picture photographed by the mobile device on a first lane in the first direction of the first intersection. If the first information includes the first geographical location information, the first geographical location information is further used by the server to determine the first direction and an identifier of the first lane. If the first information includes the identifier of the first intersection, the first information further includes the first direction and the identifier of the first lane. There is a correspondence among the second picture, the detection result, the identifier of the first intersection, the first direction, and the identifier of the first lane. A manner in which the processing module 1202 stores the correspondence among the second picture, the detection result, and the identifier of the first intersection is specifically: storing, by the processing module 1202, the correspondence among the second picture, the detection result, the identifier of the first intersection, the first direction, and the identifier of the first lane. A manner in which the processing module 1202 obtains, through training based on the pictures and the detection results that correspond to the identifier of the first intersection and that are stored, the detection model corresponding to the first intersection is specifically: obtaining, by the processing module 1202 based on to the pictures and the detection results that correspond to the identifier of the first intersection, the first direction, and the identifier of the first lane and that are stored, the detection model corresponding to the first intersection, the first direction, and the first lane.

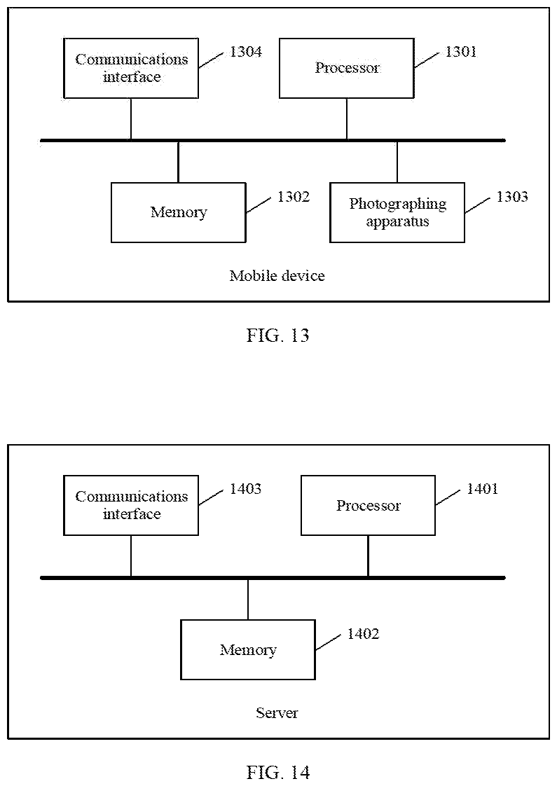

FIG. 13 is a schematic structural diagram of a mobile device according to an embodiment of this application. As shown in FIG. 13, the mobile device 1300 includes a processor 1301, a memory 1302, a photographing apparatus 1303, and a communications interface 1304. The processor 1301, the memory 1302, the photographing apparatus 1303, and the communications interface 1304 are connected.

The processor 1301 may be a central processing unit (CPU), a general-purpose processor, a coprocessor, a digital signal processor (DSP), an application-specific integrated circuit (ASIC), a field programmable gate array (FPGA) or another programmable logic device, a transistor logic device, a hardware component, or any combination thereof. Alternatively, the processor 1301 may be a combination implementing a computing function, for example, a combination including one or more microprocessors, or a combination of a DSP and a microprocessor.

The photographing apparatus 1303 is configured to photograph a picture. The photographing apparatus may be a camera or the like.

The communications interface 1304 is configured to implement communication with another device (for example, a server).

The processor 1301 invokes program code stored in the memory 1302, to perform the steps performed by the mobile device in the foregoing method embodiments.

FIG. 14 is a schematic structural diagram of a mobile device according to an embodiment of this application. As shown in FIG. 14, the mobile device 1400 includes a processor 1401, a memory 1402, and a communications interface 1403. The processor 1401, the memory 1402, and the communications interface 1403 are connected.

The processor 1401 may be a central processing unit (CPU), a general-purpose processor, a coprocessor, a digital signal processor (DSP), an application-specific integrated circuit (ASIC), a field programmable gate array (FPGA) or another programmable logic device, a transistor logic device, a hardware component, or any combination thereof. The processor 1401 may alternatively be a combination implementing a computing fiction, for example, a combination of one or more microprocessors or a combination of a DSP and a microprocessor.

The communications interface 1403 is configured to implement communication with another device (for example, a server).

The processor 1401 invokes program code stored in the memory 1402, to perform the steps performed by the mobile device in the foregoing method embodiments.

Based on a same inventive concept, problem-resolving principles of the devices provided in the embodiments of this application are similar to those of the method embodiments of this application. Therefore, for implementation of the devices, refer to implementation of the methods. For brevity, details are not described herein again.

In the foregoing embodiments, the description of each embodiment has respective focuses. For a part that is not described in detail in an embodiment, refer to related descriptions in other embodiments.

Finally, it should be noted that the foregoing embodiments are merely intended for describing the technical solutions of this application, but not for limiting this application. Although this application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of this application.

What is claimed is:

1. An information detection method, comprising the steps of:
photographing, by a mobile device, a first picture, wherein the first picture comprises a signal light at a first intersection; and
detecting, by the mobile device, a signal light status in the first picture by using a first detection model, wherein the first detection model is a detection model corresponding to the first intersection, the first detection model being obtained by a server through training based on signal light pictures corresponding to the first intersection and signal light statuses in the signal light pictures, the signal light statuses in the signal light pictures being obtained through detection using a general model, the general model being obtained through training based on pictures in a first set and a signal light status in each picture in the first set, and the first set including signal light pictures of a plurality of intersections.

2. The method according to claim 1, wherein before the photographing, the method further comprises:
photographing, by the mobile device, a second picture, wherein the second picture comprises a signal light at the first intersection;
detecting, by the mobile device, a signal light status in the second picture by using the general model, to obtain a detection result; and
sending, by the mobile device, first information to the server, wherein the first information comprises the second picture and the detection result,
wherein the first information further comprises first geographical location information of the mobile device or an identifier of the first intersection, the first geographical location information being used by the server to determine the identifier of the first intersection, with a correspondence among the second picture, the detection result, and the identifier of the first intersection,
wherein the first information is used by the server to store the correspondence among the second picture, the detection result, and the identifier of the first intersection, and
wherein the pictures and detection results that correspond to the identifier of the first intersection and that are stored in the server are used to obtain, through training, the detection model corresponding to the first intersection.

3. The method according to claim 1, wherein before the detecting, the method further comprises:
sending, by the mobile device to the server, an obtaining request used to obtain the first detection model, wherein the obtaining request carries second geographical location information of the mobile device or the identifier of the first intersection, and the second geographical location information is used by the server to determine the identifier of the first intersection; and
receiving, by the mobile device, the first detection model sent by the server.

4. The method according to claim 2,
wherein the first detection model is a detection model corresponding to both the first intersection and a first direction,
wherein the photographing of the first picture comprises photographing the first picture in the first direction of the first intersection,
wherein the photographing of the second picture comprises photographing, by the mobile device, the second picture in the first direction of the first intersection,
wherein with the first information including the first geographical location information, the first geographical location information is further used by the server to determine the first direction,
wherein with the first information including the identifier of the first intersection, the first information further comprises the first direction with a correspondence among the second picture, the detection result, the identifier of the first intersection, and the first direction,
wherein the first information is used by the server to store the correspondence among the second picture, the detection result, the identifier of the first intersection, and the first direction, and
wherein pictures and detection results that correspond to the identifier of the first intersection and the first direction and that are stored in the server are used to obtain, through training, the detection model corresponding to the first intersection and the first direction.

5. The method according to claim 2,
wherein the first detection model is a detection model corresponding to the first intersection, the first direction, and a first lane,
wherein the photographing of the first picture comprises photographing, by the mobile device, the first picture on the first lane in the first direction of the first intersection,
wherein the photographing of the second picture comprises photographing, by the mobile device, the second picture on the first lane in the first direction of the first intersection,
wherein with the first information including the first geographical location information, the first geographical location information is further used by the server to determine the first direction and an identifier of the first lane,
wherein with the first information including the identifier of the first intersection, the first information further comprises the first direction and the identifier of the first lane, with a correspondence among the second picture, the detection result, the identifier of the first intersection, the first direction, and the identifier of the first lane,
wherein the first information is used by the server to store the correspondence among the second picture, the detection result, the identifier of the first intersection, the first direction, and the identifier of the first lane, and
wherein pictures and detection results that correspond to the identifier of the first intersection, the first direction, and the identifier of the first lane and that are stored in the server are used to obtain, through training, the detection model corresponding to all of the first intersection, the first direction, and the first lane.

6. A model generation method, comprising the steps of:
receiving, by a server, first information from a mobile device, wherein the first information comprises a second picture and a detection result, the second picture comprising a signal light at a first intersection, the detection result being obtained by the mobile device through detection of a signal light status in the second picture by using a general model, the general model being obtained through training based on pictures in a first set and a signal light status in each picture in the first set, the first set comprising signal light pictures of a plurality of intersections, the first information further comprising first geographical location information of the mobile device or an identifier of the first intersection, the first geographical location information being used by the server to determine the identifier of the first intersection, with a correspondence among the second picture, the detection result, and the identifier of the first intersection;
storing, by the server, the correspondence among the second picture, the detection result, and the identifier of the first intersection; and
obtaining, by the server through training based on pictures and detection results that correspond to the identifier of the first intersection and that are stored, a detection model corresponding to the first intersection.

7. The method according to claim 6, father comprising:
receiving, by the server from the mobile device, an obtaining request used to obtain a first detection model, wherein the first detection model is the detection model corresponding to the first intersection, the obtaining request carries second geographical location information of the mobile device or the identifier of the first intersection, and the second geographical location information is used by the server to determine the identifier of the first intersection;
determining, by the server, the first detection model based on the identifier of the first intersection; and
returning, by the server, the first detection model to the mobile device.

8. The method according to claim 6, further comprising broadcasting, by the server, the first detection model to the mobile device located within a preset range of the first intersection, wherein the first detection model is the detection model corresponding to the first intersection.

9. The method according to claim 6,
wherein the second picture is a picture photographed by the mobile device in a first direction of the first intersection,
wherein the first information comprises the first geographical location information, the first geographical location information being further used by the server to determine the first direction,
wherein with the first information including the identifier of the first intersection, the first information further comprises the first direction, with a correspondence among the second picture, the detection result, the identifier of the first intersection, and the first direction,
wherein the storing comprises storing, by the server, the correspondence among the second picture, the detection result, the identifier of the first intersection, and the first direction, and
wherein the obtaining comprises obtaining, by the server through training based on pictures and detection results that correspond to the identifier of the first intersection and the first direction and that are stored, the detection model corresponding to the first intersection and the first direction.

10. A mobile device, comprising a processor, a memory, a communications interface, and a photographing apparatus, wherein
the processor, the memory, the communications interface, and the photographing apparatus are connected,
the communications interface is configured to implement communication with another device,
the photographing apparatus is configured to photograph a picture,
the memory is configured to store a computer program, the computer program including a program instruction,
the photographing apparatus is configured to photograph a first picture, the first picture comprising a signal light at a first intersection,
the processor, by executing the program instruction, causes the mobile device to:
detect a signal light status in the first picture by using a first detection model, the first detection model being a detection model corresponding to the first intersection, the first detection model being obtained by a server through training based on signal light pictures corresponding to the first intersection and signal light statuses in the signal light pictures, the signal light statuses in the signal light pictures being obtained through detection by using a general model, the general model being obtained through training based on pictures in a first set and a signal light status in each picture in the first set, and the first set comprising signal light pictures of a plurality of intersections.

11. The mobile device according to claim 10, wherein
the photographing apparatus is further configured to photograph a second picture, the second picture comprising a signal light at the first intersection,
the processor is further configured to detect a signal light status in the second picture by using the general model, to obtain a detection result,
the communications module is configured to send first information to the server,
the first information comprising the second picture and the detection result, the first information further comprising first geographical location information of the mobile device or an identifier of the first intersection,
the first geographical location information being used by the server to determine the identifier of the first intersection, with a correspondence among the second picture, the detection result, and the identifier of the first intersection,
the first information being used by the server to store the correspondence among the second picture, the detection result, and the identifier of the first intersection, and
pictures and detection results that correspond to the identifier of the first intersection and that are stored in the server are used to obtain, through training, the detection model corresponding to the first intersection.

12. The mobile device according to claim 10,
wherein the communications interface is configured to send, to the server, an obtaining request used to obtain the first detection model,
wherein the obtaining request carries second geographical location information of the mobile device or the identifier of the first intersection, and the second geographical location information is used by the server to determine the identifier of the first intersection; and
wherein the communications interface is further configured to receive the first detection model sent by the server.

13. The mobile device according to claim 11,
wherein the first detection model is a detection model corresponding to both the first intersection and a first direction;
wherein the photographing apparatus is further configured to photograph the first picture by photographing the first picture in the first direction of the first intersection,
wherein the photographing apparatus is further configured to photograph the second picture by photographing the second picture in the first direction of the first intersection,
wherein with the first information including the first geographical location information, the first geographical location information is further used by the server to determine the first direction,
wherein with the first information including the identifier of the first intersection, the first information further comprises the first direction, with a correspondence among the second picture, the detection result, the identifier of the first intersection, and the first direction,
wherein the first information is used by the server to store the correspondence among the second picture, the detection result, the identifier of the first intersection, and the first direction, and
wherein pictures and detection results that correspond to the identifier of the first intersection and the first direction and that are stored in the server are used to obtain, through training, the detection model corresponding to the first intersection and the first direction.

14. The mobile device according to claim 11,
wherein the first detection model is a detection model corresponding to all of the first intersection, the first direction, and a first lane,
wherein the photographing apparatus photographs the first picture by photographing the first picture on the first lane in the first direction of the first intersection,
wherein the photographing apparatus photographs the second picture by photographing the second picture on the first lane in the first direction of the first intersection,
wherein with the first information including the first geographical location information, the first geographical location information is further used by the server to determine the first direction and an identifier of the first lane,
wherein with the first information including the identifier of the first intersection, the first information further comprises the first direction and the identifier of the first lane, with a correspondence among the second picture, the detection result, the identifier of the first intersection, the first direction, and the identifier of the first lane,
wherein the first information is used by the server to store the correspondence among the second picture, the detection result, the identifier of the first intersection, the first direction, and the identifier of the first lane, and
wherein pictures and detection results that correspond to the identifier of the first intersection, the first direction, and the identifier of the first lane and that are stored in the server are used to obtain, through training, the detection model corresponding to all of the first intersection, the first direction, and the first lane.

15. A server, comprising a processor, a memory, and a communications interface, wherein
the processor, the memory, and the communications interface are connected,
the communications interface is configured to implement communication with another device,
the memory is configured to store a computer program, the computer program including a program instruction,
the communications interface is configured to receive first information from a mobile device,
the first information comprises a second picture and a detection result, the second picture comprising a signal light at a first intersection, the detection result being obtained by the mobile device through detection of a signal light status in the second picture by using a general model, the general model being obtained through training based on pictures in a first set and a signal light status in each picture in the first set, the first set comprising signal light pictures of a plurality of intersections, the first information further comprising first geographical location information of the mobile device or an identifier of the first intersection, the first geographical location information being used by the server to determine the identifier of the first intersection, with a correspondence among the second picture, the detection result, and the identifier of the first intersection,
the memory is configured to store the correspondence among the second picture, the detection result, and the identifier of the first intersection, and
the processor is configured to obtain, through training based on pictures and detection results that correspond to the identifier of the first intersection and that are stored, a detection model corresponding to the first intersection.

16. The server according to claim 15, wherein
the communications interface is further configured to receive, from the mobile device, an obtaining request used to obtain a first detection model, the first detection model being the detection model corresponding to the first intersection, the obtaining request carrying second geographical location information of the mobile device or the identifier of the first intersection, and the second geographical location information being used by the server to determine the identifier of the first intersection,
the processor is further configured to determine the first detection model based on the identifier of the first intersection, and
the communications interface is further configured to return the first detection model to the mobile device.

17. The server according to claim 15,
wherein the communications interface is further configured to broadcast the first detection model to the mobile device located within a preset range of the first intersection, and
wherein the first detection model is the detection model corresponding to the first intersection.

18. The server according to claim 15,
wherein the second picture is a picture photographed by the mobile device in a first direction of the first intersection,
wherein with the first information including the first geographical location information, the first geographical location information is further used by the server to determine the first direction,
wherein with the first information including the identifier of the first intersection, the first information further comprises the first direction, with a correspondence among the second picture, the detection result, the identifier of the first intersection, and the first direction,
wherein the memory is further configured to store the correspondence among the second picture, the detection result, the identifier of the first intersection, and the first direction, and
wherein the processor is further configured to obtain, through training based on pictures and detection results that correspond to the identifier of the first intersection and the first direction and that are stored, the detection model corresponding to the first intersection and the first direction.

19. A non-transitory computer-readable storage medium, storing a computer program that, when executed by a processor, causes the processor to perform the steps of:
photographing, by a mobile device, a first picture, wherein the first picture comprises a signal light at a first intersection; and
detecting, by the mobile device, a signal light status in the first picture by using a first detection model, wherein the first detection model is a detection model corresponding to the first intersection, the first detection model being obtained by a server through training based on signal light pictures corresponding to the first intersection and signal light statuses in the signal light pictures, the signal light statuses in the signal light pictures being obtained through detection using a general model, the general model being obtained through training based on pictures in a first set and a signal light status in each picture in the first set, and the first set including signal light pictures of a plurality of intersections.
